(19) United States
(12) Patent Application Publication
(10) Pub. No.: US 2015/0305545 A1
(43) Pub. Date: Oct. 29, 2015

(54) Coffee Filter Insert

(71) Applicant: George Pinkston, Sheffield, AL (US)

(72) Inventor: George Pinkston, Sheffield, AL (US)

(21) Appl. No.: 14/691,146

(22) Filed: Apr. 20, 2015

Related U.S. Application Data
(60) Provisional application No. 61/981,259, filed on Apr. 18, 2014.

(51) Int. Cl. A47J 31/06; F16B 2/24

(52) U.S. Cl. CPC A47J 31/0642; F16B 2/248

(57) ABSTRACT

A coffee filter insert device for holding a coffee filter in an open configuration during the brewing process. The coffee filter insert is configured as a substantially circular loop or ring composed of a single wire. The wire has a serpentine shaped structure such that it has a plurality of sinusoidal waves. The coffee filter insert is capable of being inserted into the interior volume of a coffee filter in order to prevent the collapse and deformation of the sidewalls of the coffee filter during the brewing process. The coffee filter insert is preferably semi-rigid in order to enable the user to manually adjust the configuration thereof and thereafter the manually formed structure retains the desired shape. The coffee filter insert is composed of a durable, heat resistant material that will not inhibit or interfere with the operation of the coffee maker.

### CROSS REFERENCE TO RELATED APPLICATION

This application claims the benefit of U.S. Provisional Application No. 61/981,259 filed on Apr. 18, 2014. The above identified patent application is herein incorporated by reference in its entirety to provide continuity of disclosure.

### BACKGROUND OF THE INVENTION

### Field of the Invention

The present invention relates to coffee filter inserts. More specifically, the present invention relates to a coffee filter insert that can be placed within the interior volume of a coffee filter for shaping, forming and maintaining the structural integrity thereof. The coffee filter insert comprises a loop of wire having a substantially circular shape, wherein the wire includes a serpentine configuration so as to fit along the grooves and ridges of the coffee filter and so as to support the coffee filter's walls in order to prevent the same from collapsing during the coffee brewing process.

When brewing coffee, coffee filters often collapse causing coffee grinds to enter the coffee pot, which can make the coffee distasteful and unappealing. Traditional coffee filters are often composed of a thin, paper-like material that may not remain in an upright position when placed within a coffee basket, especially as water enters the filter. Further, when the coffee filter collapses, coffee grinds enter the basket and other areas of the coffee pot causing the quality and effectiveness of the coffee maker to decrease.

Accordingly, a device for helping to prevent a coffee filter from collapsing while coffee is brewing is desired. The present invention provides a device that can be used to support a coffee filter and that does not interfere with the coffee brewing process. The present invention can be placed within the coffee filter in order to enable the coffee filter to remain upright when placed in a coffee filter basket and a coffee maker, thus preventing grinds and other debris from entering the coffee while brewing.

### SUMMARY OF THE INVENTION

In view of the disadvantages inherent in the known types of coffee filter inserts now present in the prior art, the present invention provides a new coffee filter insert for shaping, forming, and maintaining the structural integrity of a coffee filter when placed in the interior volume thereof, wherein the same can be utilized for supporting the walls of a coffee filter during the brewing process.

It is therefore an object of the present invention to provide a new and improved coffee filter insert device that has all of the advantages of the prior art and none of the disadvantages.

It is another object of the present invention to provide a coffee filter insert having a serpentine shaped structure.

It is another object of the present invention to provide a coffee filter insert for placement within the interior volume of a coffee filter to prevent collapse and deformation and to maintain the structural integrity thereof.

It is another object of the present invention to provide a coffee filter insert adapted to conform to the grooves, ridges, and contours of a coffee filter.

Another object of the present invention is to provide a coffee filter insert that is composed of a semi-rigid material so that the user may adjust the coffee filter insert to fit the shape of the coffee filter basket in which it will be used.

Another object of the present invention is to provide a coffee filter insert that is able to be manually formed into a desired shape by the user.

Yet another object of the present invention is to provide a coffee filter insert that is composed of a durable and heat resistant material.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front view of the coffee filter insert having a serpentine shaped structure.

FIG. 2 shows a view of the coffee filter insert in use.

### DETAILED DESCRIPTION OF THE INVENTION

Reference is made herein to the attached drawings. Like reference numerals are used throughout the drawings to depict like or similar elements of the coffee filter insert. For the purposes of presenting a brief and clear description of the present invention, the preferred embodiment will be discussed as used for shaping, forming and maintaining the structural integrity of a coffee filter, wherein the device can be placed within the interior volume of a coffee filter in order to prevent the collapse thereof. The figures are intended for representative purposes only and should not be considered to be limiting in any respect.

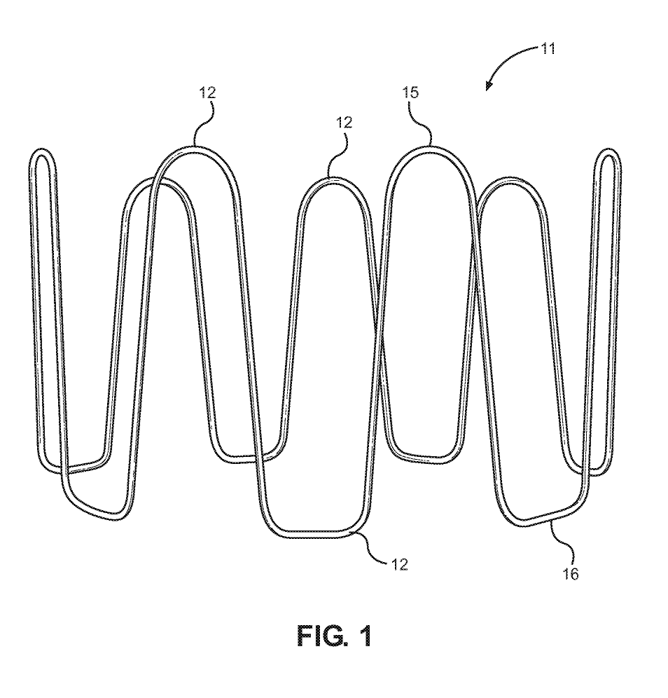

Referring now to FIG. 1, there is shown a front view of the coffee filter insert. The coffee filter insert 11 comprises an elongated wire formed into a loop or ring shape so as to define an open central area. Thus, the coffee filter insert 11 is one continuous loop of wire. The coffee filter insert 11 is preferably substantially circular in shape so as to fit within a coffee filter basket. The elongated wire of the coffee filter insert 11 is further configured into a serpentine shape. Preferably, the serpentine shape includes a plurality of sinusoidal waves 12 that extend in a substantially vertical direction. Thus, the coffee filter insert 11 comprises a circular shape in a horizontal plane, and includes waves in a vertical direction, perpendicular to said horizontal plane. The sinusoidal waves 12 are arranged such that there is an open space created in between each sinusoidal wave. The waves 12 preferably comprise rounded upper ends 15 and rounded lower ends 16 so that the wire does not puncture or damage the coffee filter.

The coffee filter insert 11 is adapted to be used with a standard paper coffee filter having grooves and ridges. The coffee filter insert 11 can be placed into the filter basket over a coffee filter, wherein the wire can contact and rest flush against the interior sidewalls of the coffee filter in order to maintain the structural integrity of the wall of the coffee filter and to prevent the collapse and deformation thereof. The waves 12 fit within the ridges and grooves of the coffee filter so as to allow the coffee filter to retain its conventional shape and positioning. However, the coffee filter insert 11 is not limited for use with a coffee filter having ridges and grooves, but can be utilized with a cone-shaped coffee filter and/or other suitable coffee filters.

The coffee filter insert 11 can be composed of various suitable materials that are durable and heat resistant, such as aluminum, stainless steel, and heat resistant plastic or rubber. Further, the coffee filter insert 11 is preferably composed of a corrosion resistant material or may have a corrosion resistant coating thereon. The coffee filter insert 11 is semi-rigid so that it maintains its shape, but can be manually adjusted in configuration when the user applies pressure thereto. Once the user applies pressure or force to the coffee filter insert 11, the coffee filter insert 11 retains the adjusted configuration. However, in an alternative embodiment, the coffee filter insert 11 is substantially rigid in structure having little to no flexibility, wherein the coffee filter cannot be manually formed into a desired shape and is adapted to fit into a standard coffee filter having grooves or ridges.

The serpentine wire of the coffee filter insert 11 is preferably thin, however in alternate embodiments the coffee filter insert 11 can comprise a greater thicknesses or cross section in order to cover more surface area of the coffee filter. In some embodiments, the waves of the wire are rectangular so that some portions of the wire are horizontal while other portions are vertical. In this way, the vertical portions are substantially parallel to one another.

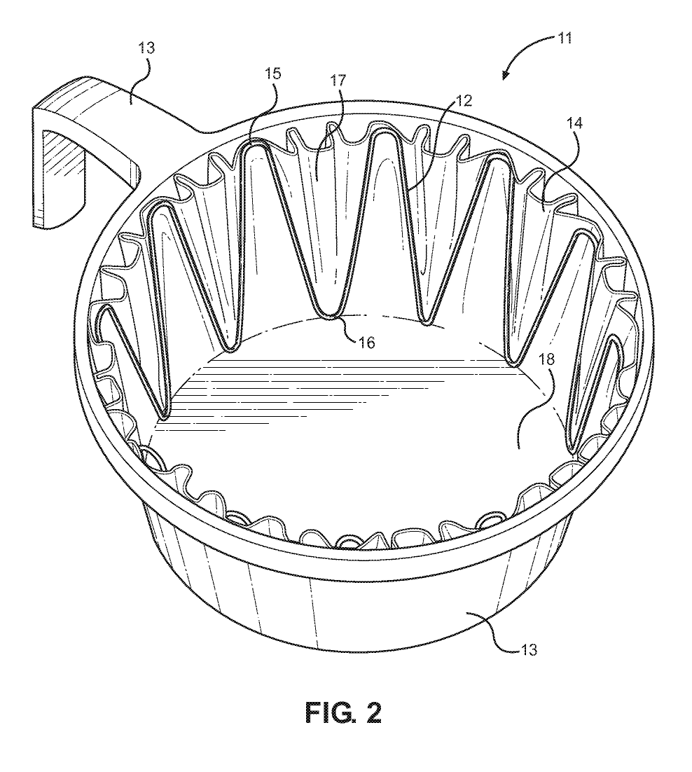

Referring now to FIG. 2, there is shown a view of the coffee filter insert 11 having a serpentine shaped structure placed into the interior volume of a coffee filter 14, wherein the coffee filter 14 is placed within the filter basket 13 of a coffee maker. In operation, the user can insert a coffee filter 14 into a filter basket 13 in the conventional manner. However, the walls 17 of the coffee filter 14 are not secured to the walls of the filter basket 13 and can easily collapse or fold towards the interior of the coffee filter 14.

In order to prevent the walls from collapsing, the user can place the coffee filter insert 11 into the interior volume of a coffee filter 14, wherein the lower end 16 of the coffee filter insert 11 rests against the lower end 18 of the coffee filter 14, and the waves 12 of the wire rest flush against the interior of the walls 17 of the coffee filter 14. The waves 12 of the coffee filter insert 11 can fit within the grooves or ridges of the coffee filter 14 so as to provide support to the coffee filter while allowing the coffee filter to retain its shape. In this way, the waves 12 prevent the coffee filter from collapsing.

Further, the user can manually form the coffee filter insert 11 into a desired shape in order to accommodate the dimensions of the filter basket, wherein the coffee filter insert 11 will retain the manually formed shaped thereafter. Thus, the user can compress the serpentine wire so that the waves are tighter or are closer together and so as to adjust the diameter of the coffee filter insert 11. Thus, the waves 12 can be adjusted or formed such that the open area between each of the waves 12 can be larger or smaller as desired. The user can manually grasp the wall and pull the waves 12 toward or away from one another as desired, wherein the waves 12 will retain the position thereafter. Further, the user can bend the wire so that the waves are tilted at an angle similar to the incline of the coffee filter basket. The user can then proceed to place the coffee filter insert 11 into the coffee filter and can continue to manually form and manipulate the coffee filter insert 11 into an optimal structure and/or shape for the coffee filter 14 in which it is placed.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A coffee filter insert comprising:
a continuous loop of wire adapted to be placed within a coffee filter so as to support a sidewall of said coffee filter;
wherein said wire comprises a serpentine shape.

2. The coffee filter insert of claim 1, wherein said wire comprises a serpentine shape, said serpentine shape comprising a plurality of sinusoidal waves.

3. The coffee filter insert of claim 2, wherein said plurality of sinusoidal waves comprise a rounded upper end and a rounded lower end, such that said rounded upper end and said rounded lower end do not puncture or damage said coffee filter.

4. The coffee filter insert of claim 1, wherein said continuous loop of wire forms a circle.

5. The coffee filter insert of claim 1, wherein said wire is composed of a semi-rigid material adapted to be formed in a desired shape and retained in said desired shape.

6. The coffee filter insert of claim 1, wherein said wire is composed of a material that is substantially rigid.

7. The coffee filter insert of claim 1, wherein said wire is composed of a heat resistant material.
